(19) United States
(12) Patent Application Publication
(10) Pub. No.: US 2011/0010191 A1
(43) Pub. Date: Jan. 13, 2011

(54) CONFIGURABLE PARTICLE SYSTEM REPRESENTATION FOR BIOFEEDBACK APPLICATIONS

(76) Inventor: Ryan Marshall Deluz, San Diego, CA (US)

Correspondence Address: Coastal Patent, LLC, P.O.BOX 232340, San Diego, CA, 92193, US

(21) Appl. No.: 12/838,673

(22) Filed: Jul. 19, 2010

Related U.S. Application Data
(63) Continuation of application No. 10/867,500, filed on Jun. 14, 2004, now abandoned.

(51) Int. Cl. G06Q 50/00

(52) U.S. Cl. 705/2

(57) ABSTRACT

A method to increase the ease and effectiveness of biofeedback by dynamically representing physiological indicators on a computer display using a configurable particle system. This particle system consists of a number of similar objects, each object having properties such as location, velocity, lifetime, color, image, transparency, size, and shape, where at least one of these properties has a random component. The objects' properties are continuously updated over time, and also updated as the physiological indicators change. The particle system can be easily set to represent physiological indicators in many different manners, or to simultaneously represent many different physiological indicators.

### CROSS-REFERENCE TO RELATED APPLICATIONS

This application is a CON of U.S. Ser. No. 10/867,500, filed Jun. 14, 2004, and titled “CONFIGURABLE PARTICLE SYSTEM REPRESENTATION FOR BIOFEEDBACK APPLICATIONS”.

### FIELD OF INVENTION

This invention relates to biofeedback, specifically to the use of a configurable particle system for displaying representations of measurable physiological indicators.

### BACKGROUND OF THE INVENTION

This invention relates to biological feedback systems, where an apparatus is used to measure a physiological indicator of a user, and where the corresponding detected signal, or an output responsive thereto, is represented to the user. This enables the user to perceive, for example, his or her heart-rate or brain activity.

This feedback teaches the user to change or control the represented physiological indicator. The representation of the detected signal is generally a line-graph, a series of bar-graphs, or a pitch change of an auditory tone such as is recommended in U.S. Pat. No. 3,890,957 to Freeman (1975). In this way, control of the auditory tone, line-graph, or series of bar-graphs represents control of the physiological indicator of the user.

This feedback is used in clinical settings where a clinician, often a psychologist or medical professional, asks a client (the user) to change the representation, thereby enabling the user to change their physiological functions towards a target-state of the user's or clinician's choosing.

Although this feedback enables users to alter their physiological indicators towards the target-state, users loose interest in line-graph representations, and become agitated by pitch change representations. This is a problem as it often requires forty half-hour sessions of watching line-graphs, or listening to pitch changes, to train the user to easily achieve the target-state.

As the capabilities and processing speed of personal computers increased, inventors created several other computerized representations of physiological indicators. U.S. Pat. No. 6,402,520 to Freer (2002) includes a display of a bug on a leaf that moves more frequently when the user achieves greater focus. U.S. Pat. No. 6,358,201 to Childre et al. (2002) includes a display of a balloon that flies when the user's heart-rate expresses a desired pattern. In 2003 the Wild Divine Project at 3330 Eldorado Springs Drive, Boulder, Colo. 80025, released an interactive biofeedback computer-game entitled “The Journey to Wild Divine” which contains representations of balls juggling, rocks stacking, doors opening, and rain falling, all of which are linked to the user's physiological indicators.

Although these graphical representations are more engaging to the user than simple line-graphs, difficulties still arise. Because the representations are generally set so that the user experiences the full range of the possibilities of the representation within a single session (from a completely closed door to a completely open door), the user tires of the repetition of the same representation over the course of multiple sessions. Additionally, users can find the representation displeasing, for instance, if the user did not like bugs as a representation. The representation can also make accessing the target-state more difficult if, for instance, the color or shape of the door was stimulating to the user, preventing the user from achieving a relaxed target-state.

To increase the variety of the representations of physiological indicators, and prevent users from tiring of using the same representation repeatedly, inventors created systems that allow the user to change the representation. However, none of these systems are versatile enough to meet the wide range of demands posed by the users of the systems.

U.S. Pat. No. 6,652,470 to Patton et al. (2003) describes a method of reducing the symptoms of an individual having attention deficit hyperactive disorder (ADHD) by first obscuring an image and subsequently allowing the user to reduce the level of obscuration by altering a physiological indicator (in this case the user's peripheral skin temperature). Since it is possible to reduce the obscuration of any image, the user can choose an image that he or she likes and that helps in the achievement of the target-state. Nevertheless, watching changes in a single image for a period of time suitable for a biofeedback session (ten to thirty minutes or more), is inadequate because it is not stimulating enough to hold most user's attention, especially for an individual having an attention deficit.

U.S. Pat. No. 6,450,820 to Palsson, et al. (2002) shows a more suitable method for individuals with ADHD. This patent describes a method and apparatus for providing feedback of the user's physiological indicators using a game of their choice from a wide selection of commercial computer games. The user's physiological indicators are represented by a change in responsiveness of the game input device (e.g., joystick or button control). The target-state used by clinicians when treating individuals with ADHD is a focused, alert state indicated by an increase in higher-frequency brain waves, and a decrease in lower-frequency brain waves. Although this is useful for individuals with ADHD, since the user can choose a game he or she is interested in, and that game will demand the user's attention, a significant number of users work to achieve a calm, less hyper-alert, target-state. A video game requiring alertness and speed of response, as well as active muscle movements, is not appropriate for these users. In addition this method of representation can only give general feedback through the change in responsiveness of the controller, and does not directly display a representation of the physiological measurements, nor does it allow for simultaneous display of multiple physiological indicators.

Control of animations, video-clips and movies, is used as a representation of physiological indicators in the Biograph Infinity™ software made by Thought Technology Ltd., 2180 Belgrave Avenue, Montreal, Quebec, Canada, H4A 2L8. This software allows the user or clinician to choose an animation or video-clip that plays forwards when the user is in the target-state and pauses, or plays backwards, if the user is not in the target-state. Although the clinician can choose a video-clip appropriate to both the user and the target-state, the representation can only be in two possible states, video-clip playing or video-clip not playing. Therefore, the user knows if he or she is in the target-state, or not in the target-state, but does not how close he or she is to achieving the target-state, and does not know if he or she is moving in the direction of achieving the target-state. This makes it more difficult for the user to achieve the target-state and also causes the user frustration. The length of the video-clips can also cause difficulty. Short video-clips must be played repeatedly in order to provide continuous feedback over the duration of one or more sessions. Longer clips, such as movies, often contain narrative elements that can influence the emotional and physiological state, and therefore the physiological indicators, of the user. The narrative elements can also cause frustration when they are paused. In addition, locating appropriate animations or video-clips and loading them into the system can be time consuming and can pose licensing issues on copyrighted media.

In the field of computer animation and special effects, “particle systems” are often used to simulate natural phenomena such as smoke, grass, clouds, fireworks, or fire. Particle systems are animated displays of similar objects, such as points, images, two-dimensional shapes, or three-dimensional objects, where each object has properties such as position, velocity, color, and lifetime and where one or more of these properties is random. These properties directly or indirectly effect the behavior of the particle, and/or how the particle is displayed.

For instance, to simulate smoke with a particle system, hundreds of semi-transparent grayish objects are used. These objects are constantly being generated at one location, move along a defined or constantly changing path, and disappear at another location after a certain amount of time has elapsed. In this instance each object would have a random (within set parameters) starting velocity, random or fixed starting location, and random grayish color, giving the entire system an unpredictable, yet unified look. This approximates the visual appearance of smoke.

A display using a number of similar objects to represent a physiological indicator was released in 2003 by “The Journey to Wild Divine” by The Wild Divine Project. There is a representation where a number of similar objects move outwards from the center of the screen in random directions. However, this software has the same difficulties present in all prior displays of physiological indicators; its ability to be configured is severely limited. There is no way for a user to change the way this representation is displayed, and thereby customize it, make it more interesting, more applicable to a target-state, create unique representations, etc. In addition, this program is not applicable for clinical use because The Wild Divine Project's hardware and software cannot display detailed, accurate, or specific information about physiological indicators and is limited to the prepackaged hardware.

Therefore this program cannot:
(1) display clinically precise information about a variety of physiological indicators
(2) allow the clinician or user to choose from many different representations
(3) allow the clinician or user to choose representations that are visually stimulating
(4) allow the clinician or user to choose representations that are attractive to the user
(5) allow the clinician or user to create unique representations
(6) allow the clinician or user to create and save, for ease of future use, representations that are attractive to an individual user
(7) allow the clinician or user to create and save, for ease of future use, representations that are appropriate to a particular target-state
(8) allow the clinician or user to easily make representations without worry of copyright infringement
(9) allow the clinician or user to easily make representations without any visual or auditory input device or knowledge of the workings of any other program or piece of equipment
(10) allow the clinician or user to display many different physiological indicators simultaneously in a manner easily understandable to the user.

### OBJECTS AND ADVANTAGES

As opposed to any of the previously mentioned representations, a configurable particle system can be used to represent physiological indicators in a variety of manners. When some of the particle system's attributes are set by the user or clinician, and others are linked to physiological indicators, the user can view a representation that assists the user in achieving the target-state, is unique to that session, and is visually attractive and stimulating to the user.

For instance, the number of the particles could be linked to the dominant frequency of the user's brain-waves, so that the number decreased as the dominant frequency decreased. In addition, the temperature of the user's hand could be linked to the brightness of the color of the particles so that the particles become darker as the hand-temperature increased. In order to decrease the brain-wave frequency and increase the hand-temperature, the user would attempt to decrease the number of particles and make the particles black.

Representing many different physiological indicators to the user simultaneously can be especially useful, as the combination of the varied indicators gives the user feedback about his or her overall state. Unfortunately, it has been difficult to represent many, for instance six, different physiological indicators at the same time, and in a manner useful to continuously display and interpret the desired feedback. Video-clip representations that can only play forward or pause cannot display enough detailed information about the combined state of six physiological indicators to guide the user into the target-state. Six line-graphs can display this detailed information, but it is very difficult for the user to make sense of six constantly changing line-graphs and simultaneously change the activities of the six lines.

A particle system can, however, simultaneously display six physiological indicators by, for instance, linking the indicators to the following six particle properties of a particle system: brightness of color, horizontal starting location, vertical starting location, speed, lifetime, and initial direction. In this case, the user would simply attempt to make the particles, for instance, turn white, start in one corner of the display, and quickly shoot the entire distance to the opposite corner of the display. The user would know if he or she was heading in the right direction as the speed incrementally increased, the lifetime increased, the direction changed, the color changed, and/or the starting location changed. In addition, the display of this representation will be different each time owing to the random attributes of the particles and the sequence of changes of the physiological indicators. The user may be more successful in altering one of his or her physiological indicators before another. This would lead, for instance, to the particles first moving to the top of the display, and then becoming faster, or, conversely, they may first become faster, and then move to the top of the display. In this way a particle system representation can display a variety of different representations based on the sequence of changes in the user's physiological indicators.

Accordingly, my configurable particle system for biofeedback applications provides several advantages over any existing representation system. It does this by:
(a) maintaining interest in the representation by:
   (1) allowing the user to choose from a great variety of different representations
   (2) allowing the user to choose representations that are visually stimulating
   (3) allowing the user to choose representations that are attractive to the user
   (4) allowing the user to create their own unique representation
(b) enhancing the clinical use of biofeedback by:
   (1) allowing the clinician to choose from a great variety of different representations
   (2) allowing the clinician to choose representations that are visually stimulating
   (3) allowing the clinician to choose representations that are attractive to the user
   (4) allowing the clinician to create unique representations
   (5) allowing the clinician to create and save, for ease of future use, representations that are attractive to an individual user
   (6) allowing the clinician to create and save, for ease of future use, representations that are appropriate to a particular target-state
   (7) allowing the clinician to easily make representations without worry of copyright infringement
   (8) allowing the clinician to easily make representations without any visual or auditory input device, or knowledge of the workings of any other program or piece of equipment.
   (9) allow the clinician to display many different physiological indicators simultaneously in a manner easily understandable to the user
(c) assisting the user to achieve the target-state more easily and more rapidly by allowing the user to:
   (1) choose a representation that is appropriate to the target-state
   (2) choose a method of change of the representation that is appropriate to the target-state
   (3) choose from many different representations that are all appropriate to the target-state and method of change of the representation
   (4) choose a representation that the user created thereby allowing the user to feel more comfortable with the representation
   (5) alter many different physiological indicators simultaneously by displaying multiple indicators in an easy to understand manner

### SUMMARY OF THE INVENTION

My invention is a method of representing one or more physiological indicators on a computer display where the display displays a plurality of similar objects, the objects having properties such as location, velocity, color, image, transparency, size, and shape, and where at least one of these properties has a random component. At least one of these properties, and/or the properties of the entire system of objects, represents the physiological indicators of a user. In addition, the user or an administering clinician can change the correlation between the physiological indicators and the representation.

### BRIEF DESCRIPTION OF THE DRAWINGS

In the drawings, closely related figures have the same number but different alphabetic suffixes.

FIGS. 1A to 1D show one possibility of the progression of a basic firework-type display. These figs do not reflect any changes in a user's physiological indicators. They simply show the natural progression of the start of a firework-type particle system. Particles begin in the center of the display as shown in FIG. 1A. The particles proceed to move outwards towards the sides of the display with each particle moving in a random direction. FIG. 1D shows the particle system display after four seconds. After this amount of time, the display will continue to look similar to FIG. 1D because new particles are constantly created in the center of the display, and older particles constantly disappear off of the sides of the display, or disappear after their lifetime ends. In the actual animated display the particle system would be highly engaging to watch as new particles constantly appear, old particles constantly disappear, and all of the particles simultaneously move, change color and change size.

FIG. 2 shows a user-interface display where the user can set the particle system's properties. The settings shown in FIG. 2 create the display shown in FIG. 1. FIG. 2 shows the particle system set to create 250 new particles (triangles) each second. These particles have a medium speed (2.0 arbitrary units per second), and a lifetime of four seconds. The particles are set to start small (1.0 arbitrary unit), and end ten-times as large (10 arbitrary units). The possible range of direction of the particles is set to be maximum (each particle is assigned a completely random direction). The emitter (defining where the particles originate) is set to the center of the display (0 on the horizontal, vertical, and depth locations) and is set to be very small (1.0 on the width, height, and depth) making the particles appear to come from the center of the display.

FIG. 3 shows a user-interface display where the user can link any or all of the particle system's properties with data from the physiological indicators. In FIG. 3 the user-interface shows the particle system property “number per second” linked with channel 1 (this could be heart-rate data), and the particle property “lifetime” linked with channel 6 (this could be skin-temperature data). As the value from channel 1 increases the number of new particles created per second will increase. As the value from channel 6 increases the lifetime of the particles will decrease, since the “Reverse” checkbox is checked.

FIGS. 4A to 4C show the use of a slider-bar. FIG. 4A shows a possible initial state of the slider-bar, where the slider-bar's box is set to the far-left side, and the corresponding numeric display shows a minimum value (1). FIGS. 4B and 4C show the same slider-bar as the user moves the box to the right towards the maximum value (250).

FIGS. 5A to 5D show the use of a drop-down list. FIG. 5A shows a possible initial state of a drop-down list. FIG. 5B shows the same list after the user has clicked on the list. FIG. 5C shows the drop-down list as the user moves the mouse over the “channel 1” option. FIG. 5D shows the drop-down list after the user has clicked on (selected) the “channel 1” option.

FIGS. 6A to 6D show one possible series of displays created using the interface shown in FIGS. 2 and 3. As a single physiological indicator changes, the particle system (consisting of circles rising) increases in the number of particles per second, and increases in the upward velocity of the particles. FIGS. 6A to 6D show four momentary displays of the particles. In the actual animated display the background color of the display and the color of the circles would be two different shades of blue. The circles would also constantly be moving, appearing, disappearing, changing color, and would therefore be engaging to watch. The circles oscillate horizontally as they rise through the display, thereby simulating bubbles rising in a swimming-pool. The circles would reach the top of the display as shown in FIG. 6D only when the velocity increased to a sufficient value.

FIGS. 7A to 7D show another possible series of displays created using the interface shown in FIGS. 2 and 3. As a single physiological indicator changes, the particle system increases in number of particles (fish), and increases in the leftward velocity of the fish. FIGS. 7A to 7D show four momentary displays of the fish. In the actual animated display the fish would be constantly moving, appearing, and disappearing. The fish would reach the left side of the display as shown in FIG. 7D only when their velocity increased to a sufficient value.

FIGS. 8A to 8D show another possible series of displays created with the settings shown in FIGS. 2 and 3. As a single physiological indicator changes, the lifetime of the particles increases. FIGS. 8A to 8D show four momentary displays of the particles. In the actual animated display the particles would be motionless. The particles would be constantly appearing, increasing slightly in size, and disappearing. The particles would fill more of the display as their lifetime increased.

FIGS. 9A to 9D show another possible series of displays created with the settings shown in FIGS. 2 and 3. As a single physiological indicator changes, the particle system decreases in number of new particles and the size of the particles decrease. FIGS. 9A to 9D show four momentary displays of the particles. In the actual animated display the particles would be constantly moving, appearing, disappearing, and changing size.

FIGS. 10A to 10D and 11A to 11D show two possible series of displays from the same user settings. As two different physiological indicators change, two properties of the particle system change. One physiological indicator is linked to the vertical location of the particles and the other is linked to the speed of the particles. FIGS. 10A to 10D show one possible sequence of changes where the particles first move towards the top of the display, and then increase in speed.

FIGS. 11A to 11D show another possible sequence where the particles first increase in speed and then move towards the top of the display. An increase in speed of the particles leads to an apparent increase in the size of the entire particle system, as the particles move farther before disappearing. These changes in the particle's properties would occur as the result of the changes in one or more physiological indicators of a user.

FIGS. 12A to 12G show a possible series of displays from a basic firework-type particle system. As six different physiological indicators change, the horizontal location, vertical location, horizontal direction, vertical direction, speed, and lifetime of the particles change. FIG. 12A shows the system located at the bottom-left corner of the display, with the particles shooting a small distance (low speed and lifetime) towards the upper-right corner of the display. FIG. 12B shows the same system located in the center of the display, with the particles shooting in all directions. FIG. 12C shows the same system located in the center of the display, with the particles shooting towards the left of the display. FIG. 12D shows the same system located in the center of the display, with the particles shooting a large distance to the right side of the display. FIG. 12E shows the same system located at the top of the display, with the particles shooting in all directions. FIG. 12F shows the same system located at the top-right corner of the display, with the particles shooting a medium distance towards the bottom-left corner of the display. FIG. 12G shows the same system located at the top-right corner of the display, with the particles shooting a large distance (high speed and lifetime) to the bottom-left corner of the display. These changes in the particle's properties would occur as the result of the changes in the six physiological indicators of the user.

### DETAILED DESCRIPTION

A preferred embodiment of the configurable particle system representation for biofeedback applications is as follows:

The embodiment is a computer program written in the programming language C++ that displays a collection of three-dimensional objects on a two-dimensional computer screen. These objects contain properties such as location, direction, speed, shape, color, image, transparency, and lifetime. The computer program uses this information to continuously update and display each object. For instance, the location is continuously updated based on the current direction. The direction could be fixed (object moves in a single direction) or could be constantly changing based on an equation (object continuously changes the direction of its movement). These objects are subsequently referred to as particles and a collection of all of these particles is referred to as a particle system.

In this program, the particles have one or more properties that are assigned random values, such as a random initial location. These values are randomly generated between an upper value and a lower value. The upper value and lower values are set so that the particle system is easily viewable. For instance, the upper and lower values of initial location should allow the particle to appear anywhere within the boundaries of the screen, but not off of the screen.

There are many different displays that can be created with this particle system. For example, a display that looks like fireworks can be constructed by assigning:
(a) a black background to the display
(b) a large number of new particles to be created each second (for instance 250 particles per second)
(c) a small size (for instance 2 pixels) to each particle
(d) the same starting location to each particle (for instance the center of the screen)
(e) a random direction to each particle
(f) a random speed to each particle (where the lower-limit is stillness, and the upper-limit allows the particle to remain on the screen for a reasonable time)
(g) a color that starts as white and fades to black over the lifetime of each particle

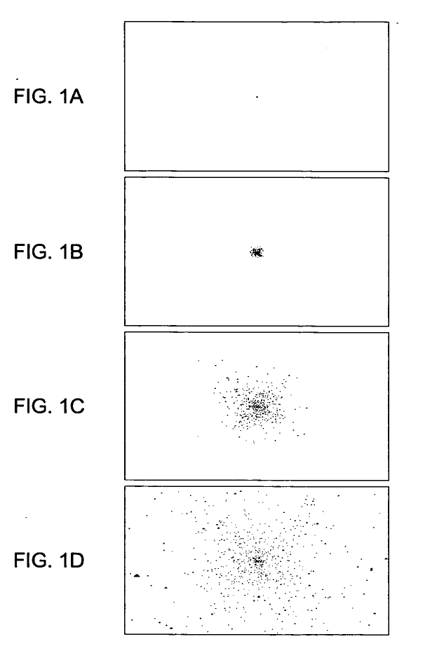

FIGS. 1A to 1D show a black and white approximation of four momentary displays over the initial four seconds as the display of the above firework representation starts (with a white background and black particles substituted for a black background and white particles). After the first four seconds the display would continue to look similar to FIG. 1D, although the particles would be constantly moving outwards from the center of the display.

The computer program keeps track of the current time and uses that time to update the particle system by creating or removing particles, moving particles, and controlling the transparency, size, location, direction, color or other properties of the particles.

The computer program uses Microsoft® DirectX® to display the particles. DirectX is a set of application programming interfaces (for C++ and other languages), used to provides a low-level hardware interface that speeds the display of three-dimensional data. This allows a complicated representation, such as a particle system, to be displayed and updated frequently enough to provide the illusion of continuous motion.

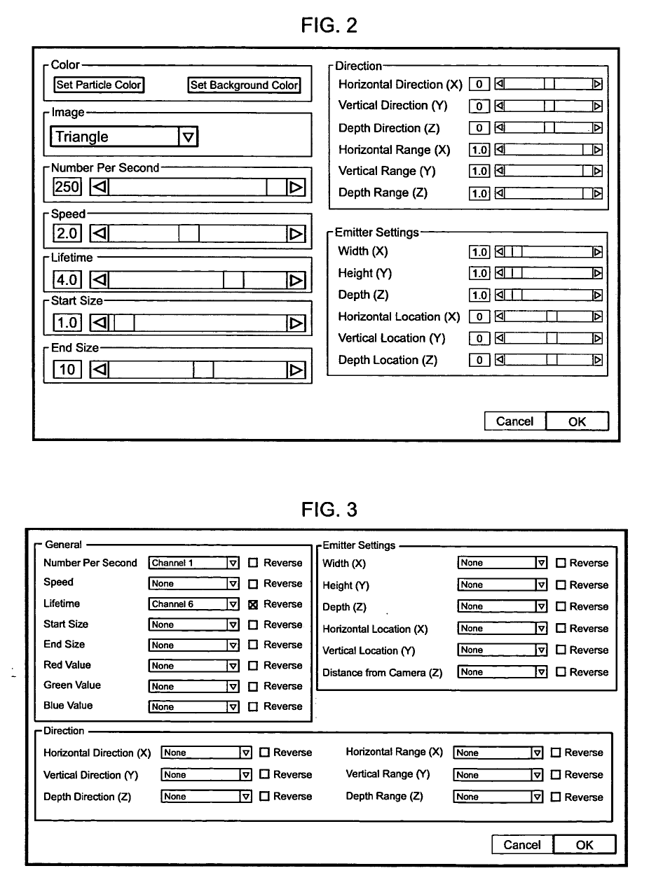

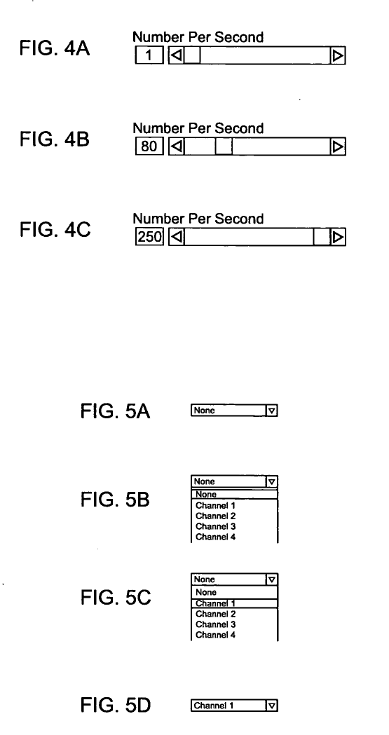

The computer program has a graphical interface (FIG. 2), including elements such as slider-bars (FIGS. 4A to 4C). This graphical interface allows a user, or clinician administering biofeedback, or clinician who plans to administer biofeedback to the user, to set the default properties or ranges of starting values of the particles.

For instance, the user or clinician could make all particles red by setting the red value to 255 (maximum), the green value to 0 (minimum) and the blue value to 0 (minimum). The user could also create a multi-colored particle system representation by setting each particle's red, green, and blue values to be randomly assigned a number between 0 and 255.

This computer program also has a graphical interface (FIG. 3), including elements such as drop-down lists (FIGS. 5A to 5D). This graphical interface allows the user or clinician to choose a physiological indicator to link to any or all of the particle properties.

For example, the user's brain-wave patterns could be linked to the speed of the particles while the skin-temperature could be linked to the initial location of the particles. To achieve a target-state of a slow dominant brain-wave frequency and a warm skin temperature the user would be instructed to decrease the particle speed and move the particles to the top of the screen.

As illustrated in FIGS. 2 and 3, the user or clinician can set a specific value for, set the limits of randomly generated values for, or set a link to a physiological indicator for:
(a) the particle's color
(b) the particle's starting size
(c) the particle's ending size
(d) the particle's image (such as a triangle, flower or fish)
(e) the particle's initial location (by settings location and dimensions of the emitter)
(f) the particle's initial direction
(g) the particle's speed
(h) the particle's lifetime (how long the particle lasts before disappearing)
(i) the number of particles that begin each second
(j) the background color of the display on which the particles appear

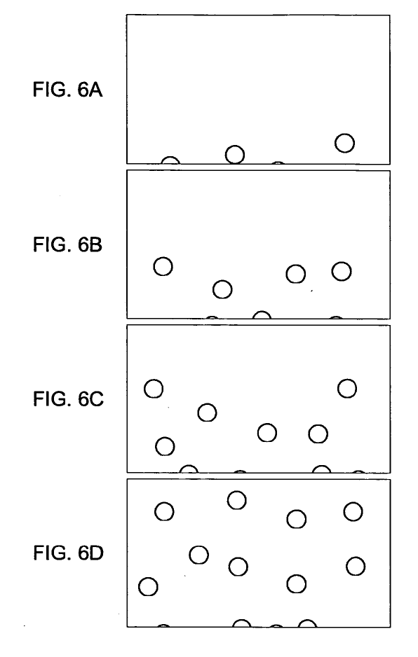

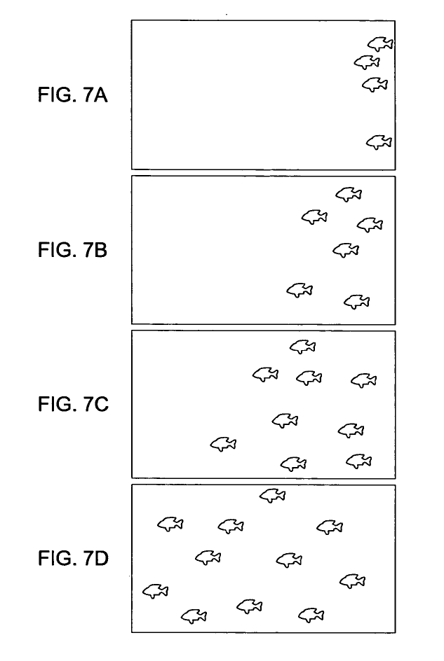

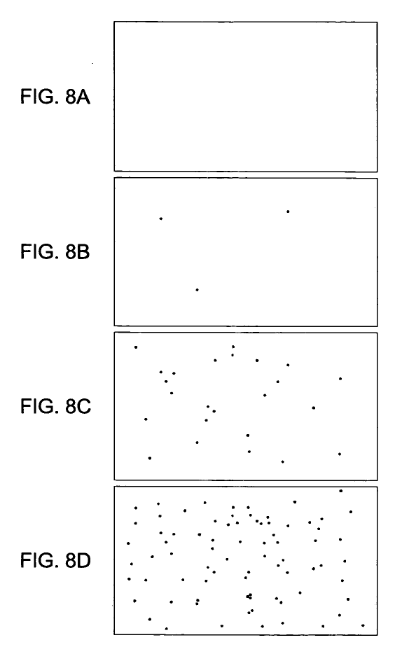

These properties can be used to create a wide variety of displays. The following is a few possible representations, out of a great many different possible representations, that can be created using the above properties.
(a) Bubbles rising in a swimming-pool (FIG. 6A to 6D)—a representation with a blue background containing particles that appear at random on the screen, each particle having the image of a bubble, and a direction that moves that particle towards the top of the screen. A physiological indicator is linked to the lifetime of the particles. Changes in the physiological indicator towards the target-state increase the lifetime of the particles allowing them to reach the top of the screen (top of the swimming-pool).
(b) Fish swimming in the sea (FIG. 7A to 7D)—a representation with a blue background containing particles, each particle having an image of a fish and moving from the right side of the screen to the left side of the screen. A physiological indicator is linked to the speed of the particles. Changes in the physiological indicator towards the target-state increase the lifetime of the particles allowing them to reach the left side of the screen.
(c) A night sky (FIG. 8A to 8D)—a representation with a black background containing white particles that appear at random on the screen, are motionless, and increase in transparency over time. A physiological indicator is linked to the lifetime of the particles. Changes in the physiological indicator towards the target-state increase the lifetime of the particles. Because new particles are being created at a fixed rate, the longer the lifetime, the more particles are displayed on the screen at any time.
(d) Five-pointed star display (FIG. 9A to 9D)—a representation with a white background containing black particles, each particle having the image of a five-pointed star and appearing at random locations on the screen and having random directions and speeds. One physiological indicator is linked to the size of the particles, another physiological indicator is linked to the number of particles created per second. Changes in the physiological indicators towards the target-state decrease the size of the particles and decrease the number of new particles created each second.

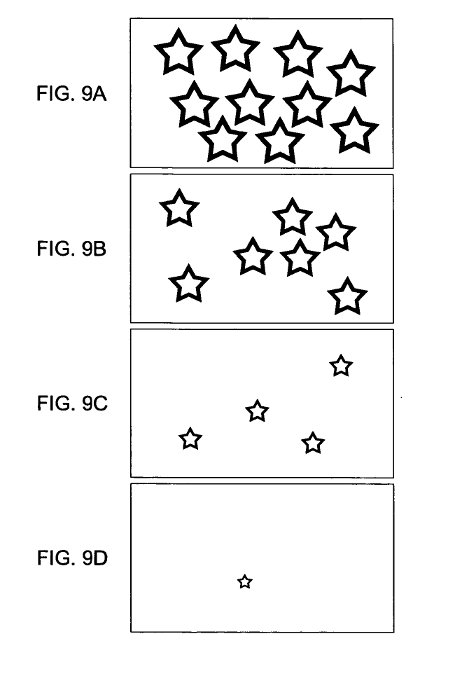

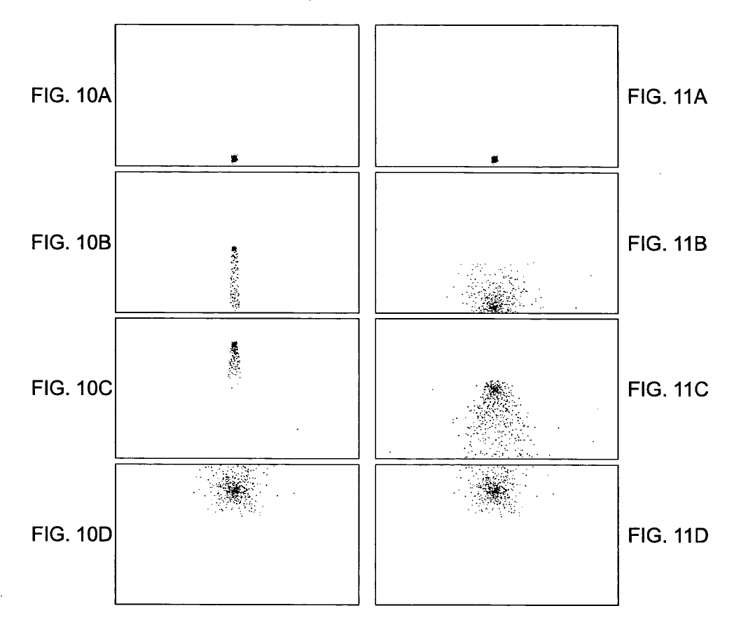

Linking multiple physiological indicators to different properties of the same particle system creates widely varying displays from the same configuration. FIGS. 10A to 10D and 11A to 11D both show the same particle system fireworks representation. This representation has the speed of the particles linked to one measured physiological indicator (channel 1), and the vertical component of the starting location of the particles linked to another measured physiological indicator (channel 2). As the physiological indicator from channel 1 increases, the speed increases. As the physiological indicator from channel 2 increases, the vertical component of the starting location of the particles increases. FIGS. 10A to 10D show the physiological indicator from channel 1 increasing first, followed by an increase in the physiological indicator from channel 2. FIGS. 11A to 11D show the opposite order of changes, with the physiological indicator from channel 2 increasing first, followed by an increase in the physiological indicator from channel 1. This causes the particle system in FIGS. 10A to 10D to first move upwards, and then increase in speed, whereas the particle system in FIGS. 11A to 11D first increases in speed, and then moves upwards.

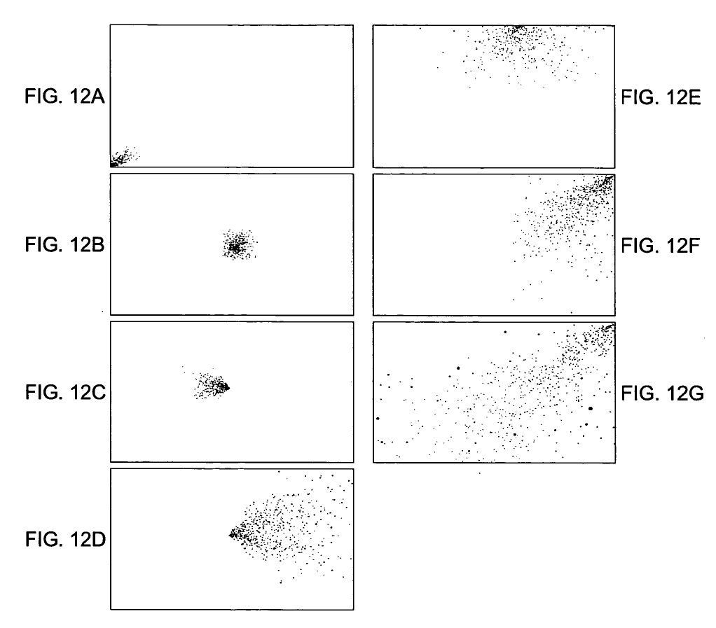

Many different physiological indicators can be linked to the wide possible variety of properties shown in FIG. 3. For instance FIGS. 12A to 12D show a possible series of changes in a particle system corresponding to changes in six different physiological indicators. The six indicators are linked to the following six particle properties: horizontal start location, vertical start location, horizontal direction, vertical direction, speed, and duration.

In addition, this computer program has a method of saving and loading all of the settings for the properties of the particle system as well as the settings that link the properties to the physiological indicators. This allows the user to save his or her favorite settings and allows the clinician to save the favorite settings of various clients. This also allows preset particle settings to be included with the program, or made by other clinicians or users and sold or freely distributed.

### Advantages

From the description above a number of advantages of my configurable particle system representation for biofeedback applications become apparent:
(a) a great variety of representations can be created by changing the properties of the particles
(b) the user or clinician can easily change the representation by dragging slider-bars that change the particle system's properties
(c) the user or clinician can easily change the representation by changing the links between the user's physiological indicators and the particle system's properties
(d) the user or clinician can easily save the representation he or she has constructed and can load it at a future time
(e) users stay interested in the representation since they are controlling the parameters of the particles through their physiological indicators, allowing for a great variety of displays, even within a particular set of settings (instead of controlling an absolute state of the entire system)
(f) the user can set, or have the clinician set, the representation to be aesthetically pleasing to him or her
(g) the user can set, or have the clinician set, the representation to be calming (for instance with a slow speed) or invigorating (for instance lots of large particles with a high speed) to him or her
(h) each particle property can be linked to a physiological indicator, creating dynamically generated representations that easily display many different physiological indicators simultaneously (as opposed to a game where an object can only move in one direction or the opposite direction such as a balloon rising or falling)

### CONCLUSION, RAMIFICATIONS, AND SCOPE

Accordingly, the reader will see that a configurable particle system representation can be used to display physiological indicators in a great variety of ways and that it is easy to change these ways with a simple graphical user-interface.

Furthermore, the configurable particle system representation allows the user or clinician to:
easily create, change, and save changes to, the representation
create representations that are pleasing to the user
create representations that are either stimulating or calming, as appropriate
simultaneously represent information from many different physiological indicators in a way that is easy to visually comprehend by the user or clinician

Although the description above contains many specificities, these should not be construed as limiting the scope of the invention, but as merely providing examples of some of the presently preferred embodiments of this invention. For example, the particle system could be programmed in another programming language such as Java® instead of C++; the particle system could be displayed using OpenGL® instead of DirectX®; the user-interface could have radio-buttons instead of drop-down lists, etc.

Thus the scope of the invention should be determined by the appended claims and their legal equivalents, rather than by the examples given.

What is claimed is:

1. A method for representing one or more physiological indicators in a biofeedback system, comprising in any order of operation the following:
(a) providing a computer with a display, said computer programmed to display a configuration window;
(b) providing an apparatus used to measure one or more physiological indicators of a user, the apparatus connected to said computer;
(c) providing a detected signal measured by said apparatus, the signal comprising at least one physiological indicator selected from: temperature, brain activity, and heart-rate;
(d) providing data stored within said computer, the data originating from said at least one physiological indicator;
(e) providing a plurality of objects for presenting on said display, said plurality of objects having at least one visual property, wherein said visual property is configured to measurably correspond to said data;
(f) providing first instructions for instructing said computer to configure one or more visual properties of said objects;
(g) providing second instructions for instructing said computer to display said objects;
(h) instructing said computer to update said visual properties of said objects to measurably correspond to said data;
(i) adjusting the configuration window to change one or more of: a rate for which the properties of said objects is updated, the corresponding property of a physiological indicator, number of objects, rate for which objects appear, lifetime of objects, shape of objects, color of objects, speed of objects, initial size of objects, final size of objects, position of objects, or background; and
(j) updating said objects according to the properties entered in the configuration window.

2. The method of claim 1, wherein said objects are substantially similarly shaped.

3. The method of claim 1, wherein said visual property is selected from: object shape, object size, object speed, object color, object lifetime, and object position.

4. The method of claim 1, wherein a size of said objects measurably corresponds to a physiological indicator.

5. The method of claim 4, wherein said physiological indicator is heart rate.

6. The method of claim 1, wherein said plurality of objects are substantially shaped as stars.

7. A biofeedback system, comprising:
a computer connected to a display, and
an apparatus for measuring one or more physiological indicators of a user;
said computer programmed to receive the one or more physiological indicators in the form of a detected signal, link the one or more physiological indicators to corresponding visual properties of a plurality of similar objects, and update said visual properties of the plurality of similar objects to correspond to the detected signal;
wherein said computer is programmed to display a configuration window for configuring one or more program inputs; and
wherein said visual properties of said plurality of similar objects are refreshed by said computer to measurably correspond to said physiological indicators at a configurable time interval.

8. The system of claim 7, wherein said physiological indicators include at least one of:
temperature, brain activity, or heart-rate.

9. The system of claim 7, wherein said visual properties are selected from: object shape, object size, object speed, object color, object lifetime, and object position.

10. The system of claim 7, wherein said configuration window includes at least one of: a slider-bar, a pull down list, or a radio button for configuring a program input.

11. The system of claim 10, wherein said program inputs include at least one of: initial object properties, rate for updating displayed objects with properties corresponding to detected physiological indicators, and background.

12. A method of representing one or more physiological indicators comprising:
(a) providing a computational system with a display, microprocessor, storage medium and memory;
(b) providing an apparatus for measuring one or more physiological indicators of a user;
(c) providing a plurality of similar objects displayed on said computational system;
(d) providing a randomness of one or more properties of said plurality of similar objects;
(e) providing a computer program for said computational system to change the display of said plurality of similar objects, said computer program including a configuration window;
(f) linking said physiological indicators to said plurality of similar objects displayed;
(g) allowing for the alteration of properties of said plurality of similar objects within said configuration window; and
(h) allowing for the alteration of the link between the physiological indicators and said plurality of similar objects within said configuration window.

13. The method of claim 12, wherein said plurality of similar objects have properties selected from the group consisting of: size, shape, color, image, transparency, location, direction, speed, and lifetime.

14. The method of claim 13, wherein the direction of said objects is configured using an equation.
